(19) United States
(12) Patent Application Publication
(10) Pub. No.: US 2010/0101457 A1
(43) Pub. Date: Apr. 29, 2010

(54) LOW EMBODIED ENERGY SHEATHING PANELS AND METHODS OF MAKING SAME

(76) Inventors: Kevin J. Surace, Sunnyvale, CA (US); Brandon D. Tinianov, Santa Clara, CA (US)

Correspondence Address: WILSON, SONSINI, GOODRICH & ROSATI, 650 PAGE MILL ROAD, PALO ALTO, CA, 94304-1050, US

(21) Appl. No.: 11/754,220

(22) Filed: May 25, 2007

(51) Int. Cl. B32B 3/26; C04B 38/00; C04B 20/00; B28B 1/14; B28B 1/48

(52) U.S. Cl. 106/674; 106/672; 106/676; 106/675; 106/679; 264/299; 264/156

(57) ABSTRACT

Sheathing panels are produced by methods which do not require natural resources such as wood and use significantly reduced embodied energy when compared with the energy used to fabricate gypsum sheathing panels. A novel binder, consisting in one embodiment of monopotassium phosphate and magnesium oxide, and combined with various fillers, is used to provide a controlled exothermic reaction to create a gypsum board-like core which can be formed into a suitable sheathing panel handled and installed in a typical manner. The panel is manufactured to have a desirable shear resistance and water vapor permeability, important performance elements in building envelope design. The manufacturing process results in a panel that does not require mature trees as source material, does not off gas, and involves much lower greenhouse gas emissions than the processes used to make traditional wood or gypsum-based sheathing panels.

### FIELD OF INVENTION

The present invention relates to new compositions and methods of manufacture for sheathing panels and in particular to panels and processes which reduce the energy required to manufacture such a sheathing panel when compared to the energy required to manufacture traditional gypsum or wood-based sheathing panels.

### BACKGROUND OF THE INVENTION

In the field of building construction, structural sheathing is a crucial element in suitable building design. It may serve many functions associated with the purpose and integrity of the assembly, including strengthening the building to lateral forces; providing a base wall to which finish siding can be nailed; acting as thermal insulation; and, in some cases, acting as a base for further thermal insulation. Sheathing, in the form of thin, rigid panels is nailed directly onto the framework of the building. Some common types of sheathing include wood boards or slats, oriented strand board (OSB) panels, plywood panels, and gypsum panels.

Before the acceptance of performance-rated cellulose panels such as oriented strand board (OSB), plywood was the sheet product of choice for constructing wood shear walls. Plywood panels are very flexible and appropriate for a variety of building designs. The panel thickness, panel grade, nail type, and nail spacing could be combined in different ways to achieve a wall with the right design strength. In the 1970s, with the advent of performance-rated products based on waferboard technology, plywood was largely replaced with composite wood panels such as OSB. Today, all of the model building codes in the U.S. and Canada recognize OSB panels for the same uses as plywood on a thickness-by-thickness basis and they are used interchangeably, based on price and availability.

A more recent optional material for use as a structural panel is gypsum sheathing panels. Gypsum sheathing is most commonly manufactured with a water-resistive treated core but may also be available in a non-treated core. Treated core gypsum sheathing is intended for use as a substrate sheathing under a variety of exterior wall claddings in any climate. Non-treated core gypsum sheathing is intended for use only in dry climates. As with their wood counterparts, both types of gypsum sheathing are designed to be mechanically attached to the outside surface of exterior wall framing using either nails, or screws, or staples. Gypsum sheathing is manufactured in range of lengths and widths similar to those of both plywood and OSB.

The sheathing layer is designed with several system properties and requirements in mind. Of particular importance are the shear resistance imparted by the layer, the water vapor permeance of the layer, the weather resistance of the layer, and finally, the environmental impact (and associated global warming) involved with the manufacture of the sheathing layer. First, an appropriate structural building design requires that the panel reliably transfer shear forces (typically from wind shear or earthquake loads) from the body of the structure to its foundation. The performance of a panel in a building design is subject to many design elements including the material's Young's modulus, the panel thickness, the type and configuration of the structural framing and the type and spacing of the panel fasteners. All of these combine for a rated shear resistance in units of pounds per foot (lb/ft).

A second, important material property of the sheathing panel is the panel's role in the moisture management across the building envelope. The problems associated with excessive moisture in building wall cavities and the resulting mold growth, are well documented in the national outcry over unhealthy buildings and poor indoor air quality. As a result, building science has established best practices for minimizing the probability of mold growth in buildings. Walls between areas of differing temperature are the primary structures for these problems. Preventing condensation is of particular importance with regard to the exterior walls of a home or other buildings, where temperature extremes are likely to be greater than between interior walls. Wetting of exterior building surfaces and rainwater leaks are major causes of water infiltration, but so is excessive indoor moisture generation. Moisture may be present within a structure due to occupancy and use by humans, use of wet materials during construction, air leaks, or transportation by external wall materials.

A figure of merit for the measurement of the transport of water vapor, by a material or method of construction, is its permeance, or “perms”. One perm is defined as the transport of one grain of water per square foot of exposed area per hour with a vapor pressure differential of 1-inch of mercury. Vapor pressure is a function of the temperature and relative humidity (RH) of the air to which a test structure is exposed, and may be found in many standard data tables. The vapor pressure at any certain RH is found by the product of the RH and the vapor pressure for saturated air at a certain temperature. For example, at 70 degrees Fahrenheit the saturated vapor pressure is 0.7392 in Hg and the vapor pressure at fifty percent RH is 0.3696. The testing methodology varies depending upon the subject material. Data presented hereinafter was taken using the ASTM E96 “dry cup” method. Further information may be found on the Internet at http://www.astm.org.

The Department of Energy (DOE) and the American Society of Heating, Refrigeration, and Air-Conditioning Engineers (ASHRAE) and other building science organizations have established recommended wall designs and the proper location of a vapor retard within the wall. These designs are dependant upon the local climate. In cooling-dominated climates, it is recommended that a vapor retarder be installed on the exterior of the thermal insulation. In mixed zones-climates with both significant heating and cooling requirements-design recommendations suggest the omission of the vapor retarder altogether. If these guidelines are not observed, the structure is at risk of allowing water vapor condensation within the wall cavity.

The rate of water vapor transmission of OSB is two perms. For sheathing grade plywood, of ½ to 1 inch thickness, the transmission rate is approximately ten perms. Gypsum sheathing typically has an average vapor permeance of 20 perms. Therefore, plywood and gypsum are above the accepted minimum of five perms when the “U” value (a measure of thermal conductance) of the wall is less than 0.25 and a vapor retarder not exceeding one perm is installed on the interior side of the framing and avoids a double vapor retarder condition. However, OSB would be deemed unacceptable in the same assembly.

Gypsum sheathing is designed for use as a substrate that is covered by an exterior wall cladding. Local weather conditions will dictate the length of time gypsum sheathing may be left exposed; however, it should perform satisfactorily if exposed to the elements for up to one month. Treated core gypsum sheathing should be covered immediately with a weather-resistive barrier, such as building felt or equivalent, if exposure time will exceed one month or weather conditions will be severe. Non treated core gypsum sheathing shall be covered immediately after installation with a weather-resistive barrier. Gypsum sheathing does not hold peel and stick water barrier well.

Another important consideration in the design and manufacture of construction materials is their potential negative environmental impact. Environmental impact can take many forms including the depletion of non-renewable natural resources (such as fossil fuels, for example), the generation of harmful chemicals or compounds, or the creation of greenhouse gasses. For a complete assessment as to the suitability of a construction material, the existing offering of sheathing materials should be considered in this context as well.

Unfortunately, the structural integrity of plywood is dependent upon the inclusion of quality wood laminates harvested from mature, large diameter trees, at least 30 years old. Their manufacture puts stress on old growth forests and existing woodland areas. As a result, much of the U.S. softwood plywood industry has shifted from the Pacific Northwest to the South and Southeast, to pine plantations on private lands. These small pines produce a lower quality panel than from the previously abundant older trees. In addition, their costs have risen over the last decade, making them less desirable as a mainstay construction material. OSB has at least two distinct advantages over traditional plywood panels. First, they do not require old growth forests, or decades old trees for their manufacture. OSB is derived from younger aspen trees of a much smaller relative diameter. Although the aspen wood is not a rapidly renewable resource, it does lessen the OSB' s impact on endangered woodlands. However, OSB extends the use of potentially dangerous resins such as phenol formaldehydes listed by IARC as a potential carcinogen that may be released as a VOC during its service life.

Gypsum sheathing panels do not require the use of wood and therefore don't share the concerns associated with tree harvesting. Instead, the manufacture of gypsum sheathing represents an astounding amount of embodied energy as a construction material. The term ‘embodied energy’ is defined as “the total energy required to produce a product from the raw materials stage through delivery” of finished product. Several of the steps (drying gypsum, calcining gypsum (dehumidification), mixing the slurry with hot water and drying the manufactured boards) involved in the manufacture of gypsum sheathing take considerable energy. Greenhouse gasses, particularly CO₂, are produced from the burning of fossil fuels and also as a result of calcining certain materials, such as gypsum. Thus the gypsum manufacturing process generates significant amounts of greenhouse gasses due to the requirements of the process.

According to the National Institute of Standards and Technology (NIST—US Department of Commerce), specifically NISTIR 6916, the manufacture of gypsum sheathing panel requires 8,196 British Thermal Units (BTU) per pound. With an average ⅝″ gypsum sheathing board weighing approximately 75 pounds, this equates to over 600,000 BTU's per board total embodied energy. Other sources suggest that embodied energy is less than 600,000 BTU's per board, while others suggest it may be even more. It has been estimated that embodied energy constitutes over 50% of the cost of manufacture. As energy costs increase, and if carbon taxes are enacted, the cost of manufacturing sheathing panel from calcined gypsum will continue to go up directly with the cost of energy. Moreover, material producers carry the responsibility to find less-energy dependent alternatives for widely used products as part of a global initiative to combat climate change.

For comparison, the same energy study (NISTIR 6916) reports that a total of 18600 BTU's per panel are required for the wood harvesting and manufacture of plywood sheathing. OSB sheathing requires a similar amount of energy in its manufacture. Report NISTIR 6916 calculated 27100 BTU's per panel for OSB sheathing.

In summary, a product's potential negative environmental impact can take many forms, including a depletion of natural resources such as trees, potable water and materials in short supply, or the negative impact may be in the form of a significant consumption of energy during the product's manufacture and the resulting generation of greenhouse gasses from its production.

Thus, it would be highly desirable to meet all of the performance requirements of a structural sheathing panel while reducing the environmental impact of its manufacture either through the harvesting of trees, the use of harmful chemicals, or the generation of dangerous greenhouse gasses via a high embodied energy.

### SUMMARY OF INVENTION

In accordance with the present invention, new methods of manufacturing novel sheathing panels (defined herein as “EcoRock™” sheathing panels), are provided. The resulting novel EcoRock sheathing panels can replace plywood, OSB, and gypsum sheathing panels in most construction applications. Sheathing panels formulated and manufactured in a prescribed way maintain the required structural integrity, water vapor permeance, and weather resistance, while significantly reducing the environmental impact associated with the other existing sheathing materials, thus substantially reducing future harm to the environment.

This invention will be fully understood in light of the following detailed description taken together with the drawings.

### DRAWINGS

FIG. 1 is a perspective view of a sheathing panel according to a preferred embodiment of the invention.

FIG. 2 shows an EcoRock sheathing panel mold with multiple embedded pins/columns to allow for optimal water vapor transmission

FIG. 3 shows an EcoRock sheathing panel mold as a continuous slab designed for further fabrication steps to allow for optimal water vapor transmission

FIG. 4 shows the EcoRock sheathing panel manufacturing steps which as shown require little energy.

FIG. 5 shows the EcoRock sheathing panels installed to framed structure.

### DETAILED DESCRIPTION

The following detailed description of embodiments of the invention is illustrative only and not limiting. Other embodiments will be obvious to those skilled in the art in view of this description. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. Various changes in the details may be made without departing from the spirit, or sacrificing any of the advantages of the present invention. The detailed descriptions below are designed to make such embodiments obvious to a person of ordinary skill in the art.

The novel processes as described herein for manufacturing a low embodied energy novel sheathing panel lessen the environmental impact created by traditional materials. In comparison to wood products (such as plywood and OSB) there is no depletion of trees as a natural resource. As an alternative to gypsum, the novel sheathing panels of this invention and the processes for their manufacture eliminate the most energy intensive prior art processes in the manufacture of current gypsum sheathing panels such as gypsum drying, gypsum calcining, the generation of hot water, and board drying. The new processes allow sheathing panels to be formed from non-calcined materials which are plentiful and safe and which can react naturally to form strong, shear resistant boards that are also weather hardy and with acceptable water vapor permeability.

The new EcoRock sheathing panels contain a binder of one or more of magnesium oxide (MgO), calcium oxide, calcium hydroxide, iron oxide (Hematite or Magnetite) and a solution of alkali phosphate salt (sodium phosphate, potassium phosphate, monopotassium phosphate, tripotassium phosphate, triple super phosphate, calcium dihydrogen phosphate, dipotassium phosphate or phosphoric acid). The selected binder materials, often in conjunction with fillers, are mixed together at the start of the particular EcoRock manufacturing process or processes selected to be used to form the EcoRock sheathing panel or sheathing panels. Prior to the addition of liquids, such as water, this mix of binder and filler powders is termed a “dry mix.” The MgO may be calcined or uncalcined. However uncalcined MgO may be less expensive and provide significant energy savings over calcined MgO. Thus there is no need to use calcined MgO, even though calcined MgO can be used in the EcoRock sheathing panel processes.

In U.S. patent application Ser. No. 11/652,299 [Docket Number M-16789 US, filed Jan. 11, 2007] Surace et al. describe a novel interior gypsum wallboard replacement using such an EcoRock formulation. Application Ser. No. 11/652,299 is assigned to the same assignee as is this application and is hereby incorporated herein by reference in its entirety. While there are many binder ingredients in the Surace panel similar to the binder ingredients used in the present EcoRock sheathing panel, the present sheathing panel as intended for use in building construction is not described nor contemplated by Surace. Nor does Surace describe any embodiment with manufacturing features which optimize the water vapor transmission of the panel, a property which is an important characteristic of sheathing panels.

Many different configurations of materials are possible in accordance with this invention, resulting in improved strength, hardness, score/snap capability, paper adhesion, thermal resistance, weight, and fire resistance. The binder is compatible with many different fillers including calcium carbonate (CaCO₃), wolastinite (calcium silicate), cornstarch, ceramic microspheres, perlite, flyash, waste products and other low-embodied energy materials. Uncalcined gypsum may also be used as a filler material. By carefully choosing low-energy, plentiful, biodegradable materials as fillers, such as those listed above, the sheathing panel begins to take on the best characteristics of wood-based and gypsum sheathing panels. These characteristics (structural strength, weight—so as to be able to be carried, water vapor permeability, and the ability to be nailed or otherwise attached to other materials such as studs) are important to the marketplace and may be required to make the product a commercial success as a traditional sheathing panel replacement.

Calcium carbonate (CaCO₃), an acceptable alternate filler material, is plentiful and represents an environmentally favorable choice. Cornstarch, made from corn, is plentiful and non toxic. In addition, ceramic microspheres are a waste product of coal-fired power plants, and can reduce the weight of materials as well as increase thermal and fire resistance of the sheathing panels that incorporate these materials. The dry mix can include up to 60% by weight of ceramic microspheres. Such a dry mix may be successfully incorporated in EcoRock sheathing panels. Higher concentrations of dry mix increase cost and can reduce strength below acceptable levels. Fly ash is also a waste product of coal-fired power plants which can be effectively reutilized in the dry mix. The dry mix can include up to 80% by weight of fly ash. Such a dry mix has been successfully incorporated into EcoRock sheathing panels; however very high concentrations of fly ash can increase weight, darken the core color, and harden the core beyond a level that may be undesirable. Biofibers (i.e. biodegradable plant-based fibers) are used for tensile and flexural strengthening in this embodiment; however other fibers, such as cellulose or borosilicate glass fibers, may also be used. The use of specialized fibers in cement boards is disclosed in U.S. Pat. No. 6,676,744 and is well known to those practicing the art.

In a preferred embodiment of the present invention, a dry mix of powders plus water is created using the materials listed in TABLE 1 by both volume and weight:

TABLE 1

| Material | % Volume | % Weight | Notes |
|---|---|---|---|
| Oxide | 6.91% | 5.39% | Magnesium Oxide |
| Phosphate | 13.08% | 15.98% | Monopotassium Phosphate |
| Filler | 11.20% | 11.59% | Calcium Silicate |
| Fibers | 1.77% | .40% | Bio based Fibers |
| Lightener | 32.20% | 29.96% | Ceramic Microspheres |
| Retarder | .19% | .20% | Boric Acid |
| Water | 34.65% | 36.48% | Water |
| Total | 100.00% | 100.00% | |

Monopotassium phosphate and magnesium oxide together form a binder in the slurry and thus in the to-be-formed core of the EcoRock sheathing panel. Calcium carbonate, cornstarch and ceramic microspheres form a filler in the slurry while the biofibers strengthen the core, after the slurry has hardened. Boric acid is a retardant to slow the exothermic reaction and thus slow down the setting of the slurry.

In terms of manufacturing steps, the water, equivalent to about 37% of the dry mix by weight, is added to the dry mix to form a slurry. The wet mix (termed the “initial slurry”) is mixed by the mixer in one embodiment for three (3) minutes. Mixers of many varieties may be used, such as a pin mixer, provided the mix can be quickly removed from the mixer prior to hardening.

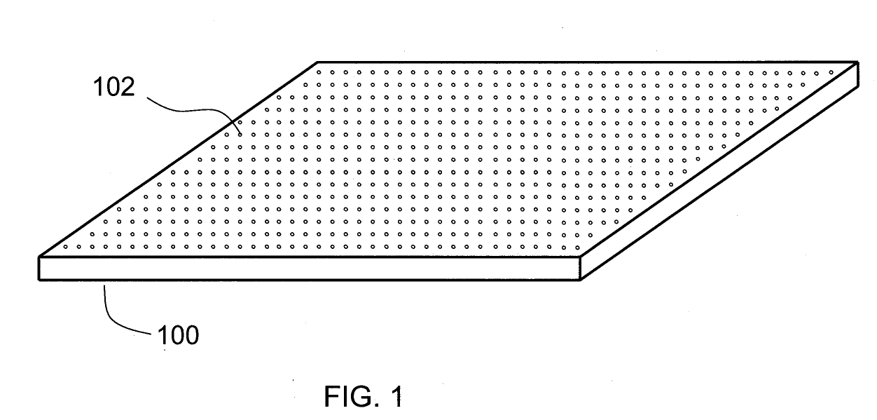

In order to meet all of the sheathing material requirements, the bulk EcoRock may not have a water vapor permeability acceptable for all wall designs. For this reason, several embodiments of the invention involve discrete perforations using an array of mechanical elements. A representation of such a perforation arrangement is shown in FIG. 1 in a perspective view.

FIG. 1 shows a proposed embodiment of the present invention whereby the novel cement mixture such as set forth in Table 1 is formed into perforated panels. Panel 100 is of typical construction panel dimensions of approximately 4 feet by 8 feet by ⅝ inches thick, or 4 feet by 12 feet by ½ inches thick, or another typical set of dimensions. The panel 100 features an array of through penetrations 102 with a prescribed hole diameter and spacing to ensure the proper water vapor transmission while maintaining the structural integrity of panel 100. Example hole counts are from 50 to 5000 per 4 foot by 8 foot panel. The diameter of the holes ranges from 2 mm to 0.2 mm.

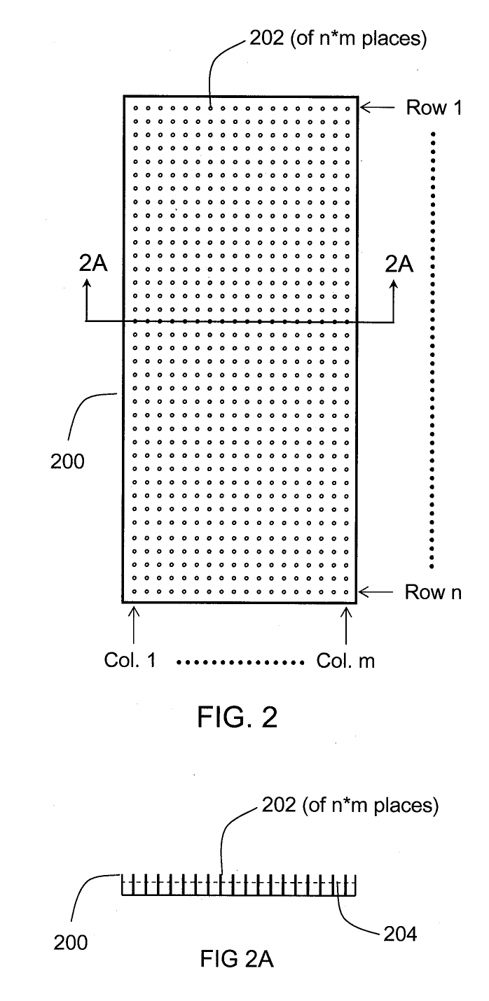

The slurry may be poured onto a panel mold that contains an array of small diameter pins or columns or 0.2 to 1 mm diameter. Such a mold is shown in FIG. 2. The mold pan 200 is of dimensions suitable for the preferred panel size, typically 4 feet by 8 feet. The pins 202 are of a given diameter and number according to the preferred panel permeance. In one embodiment, the columns are spaced on 3 inch intervals for a total of 512 total pins. The pins may be made of many materials, chosen for their strength and durability and their ability to release from the EcoRock material with little force. Preferred materials include the family of low friction plastics including Telflon. Upon curing over a typical time period of 10 to 90 minutes, the panel may be removed from the mold with a resulting array of holes corresponding to the pin positions. These holes are of the appropriate diameter and number to create the preferred water vapor permeance without allowing the transmission of liquid water. Such an embodiment is illustrated in FIG. 1. Neither backing paper nor paper adhesives are required with this embodiment, but can be added if desired. FIG. 2A shows the same mold in cross section. The pins 202 extend from the base of the mold pan 200. The dashed line 204 is the proposed upper liquid level for the slurry mixture poured to form the sheathing panel. In this embodiment, the pins extend well beyond the thickness of the panel to ensure through penetration.

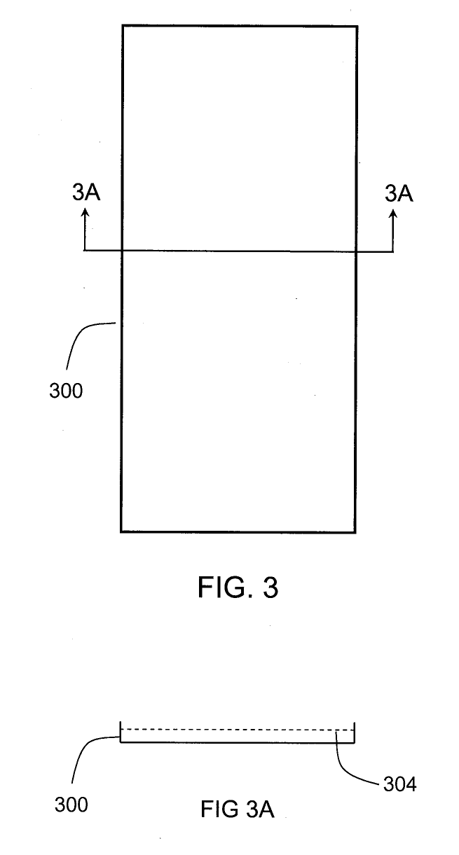

A second technique for manufacturing a panel from the disclosed formulation is to pour a continuous mold as shown in FIG. 3. As with mold pan 200, the mold pan 300 is of dimensions suitable for the preferred panel size, typically 4 feet by 8 feet. In this embodiment, there are no pins and the panel forms an uninterrupted sheet. After release from the mold, the panel is mechanically perforated by repeated drilling or laser burning. The drilled holes are again of a number and diameter according to the preferred panel permeance without allowing the transmission of liquid water. Practical hole diameters range from 0.2 to 2 mm.

Using the constituents set forth in Table 1 in paragraph 31 above, an exothermic reaction began almost immediately after removal of the materials in Table 1 from the mixer and continued for several hours, absorbing most of the water into the reaction. Boards were cut and removed in less than 30 minutes following the start of curing. All of the water had not yet been used in the reaction, and some absorption of the water continued for many hours. Within 24-48 hours, the majority of water had been absorbed, with the remaining water evaporating This was accomplished on racks at room temperature with no heat required.

The resulting boards (the “finished product”) have strength characteristics similar to strength characteristics of gypsum sheathing panels, and can be easily installed in the field.

Drying time will be faster at higher temperatures and slower at lower temperatures above freezing. Residual drying will continue to increase at higher temperatures; however it is not beneficial to apply heat (above room temperature) due to the need of the exothermic reaction to utilize the water that would thus be evaporated too quickly.

In other embodiments, the ratio of the binders monopotassium phosphate to magnesium oxide can be varied such that they are both equal amounts by weight. This can result in lower water usage. As a feature of this invention, the ratio of one binder component to the other binder component by weight can be varied to minimize the cost of materials. A combination of 10% of magnesium oxide to 90% monopotassium phosphate has been mixed demonstrating an acceptable exothermic reaction.

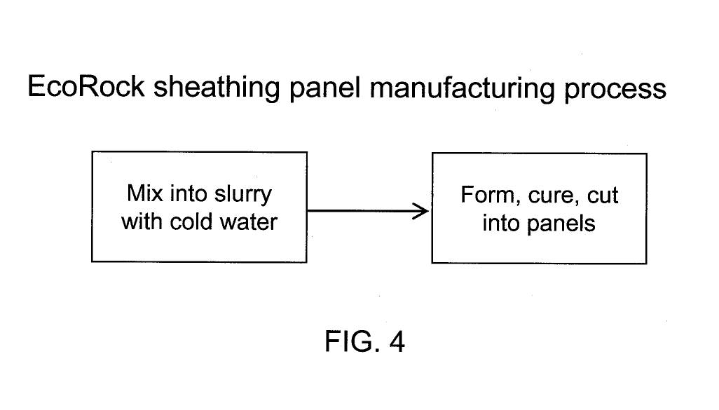

The processing of the slurry may occur using several different techniques depending on a number of factors such as quantity of boards required, manufacturing space and familiarity with the process by the current engineering staff. An example of such a process is given in FIG. 4. In the processes of this invention, an exothermic reaction between the binder components naturally starts and heats the slurry. The reaction time can be controlled by many factors including total composition of slurry, percent (%) binder by weight in the slurry, the fillers present in the slurry, the amount of water or other liquids in the slurry and the addition of a retarder such as boric acid to the slurry. Retarders slow down the reaction. Alternate retarders can include borax, sodium tripolyphosphate, sodium sulfonate, citric acid and many other commercial retardants common to the industry. FIG. 4 shows the two-step simplicity of the process of this invention; namely mixing the slurry with unheated water and then forming the wallboards from the slurry. The wallboards can either be formed in molds or formed using a conveyor system of the type used to form gypsum wallboards and then cut to the desired size.

In the process of FIG. 4, the slurry (the mixture of ingredients set forth in Table 1), starts thickening quickly. The exothermic reaction proceeds to heat the slurry and eventually the slurry sets into a hard mass. Typically maximum temperatures of 40° C. to 90° C. have been observed depending on filler content and size of mix. The hardness can also be controlled by fillers, and can vary from extremely hard and strong to soft (but dry) and easy to break. Set time, the time required prior to removal of the boards from molds or from handling on a continuous slurry line, can be designed from twenty (20) seconds up to days, depending on the additives or fillers. For instance boric acid can extend the set time from seconds to hours where powdered boric acid is added to the binder in a range of 0% (resulting in a set time of seconds) to 4% (resulting in a set time of hours). While a set time of twenty (20) seconds leads to extreme productivity, the slurry may begin to set too rapidly for high quality manufacturing, and thus the set time should be adjusted to a longer period of time typically by adding boric acid. The use of one and two tenths percent (1.2%) of boric acid gives approximately a four (4) minute set time.

The normal gypsum slurry method using a conveyor system, which is a continuous long line that wraps the slurry in paper is another acceptable method for fabricating most embodiments of the EcoRock sheathing panels of this invention. This process is well known to those skilled in manufacturing gypsum sheathing panel. Also the Hatscheck method, which is used in cement board manufacturing, is acceptable to manufacture the sheathing panels of this invention, specifically those that do not require paper facing or backing, and is well known to those skilled in the art of cement board manufacturing. Additional water is required to thin the slurry when the Hatscheck method is used because the manufacturing equipment used often requires a lower viscosity slurry. Alternatively as another manufacturing method, the slurry may be poured into pre-sized molds and allowed to set. Each board can then be removed from the mold, which can be reused.

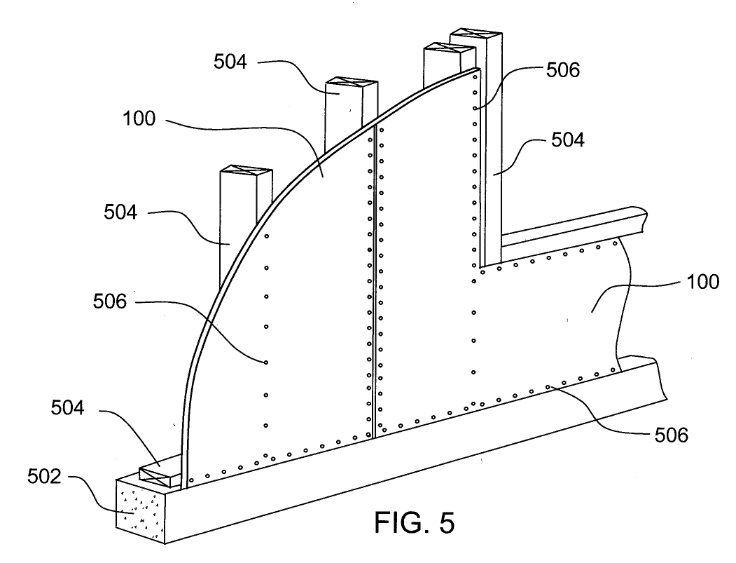

As illustrated in FIG. 5, the EcoRock sheathing panel 100 is mounted to the building's structural framing 504. A typical concrete foundation 502 supports the framing 504, both constructed in a manner prescribed by the local or national building code. The EcoRock sheathing panel 100 is placed across the exterior face of the framing members 504 and fastened with mechanical fasteners 506 such as nails or screws. The specific type and spacing is determined by local or national building codes. For the purposes of clarity, the array of very small through pore or penetrations 102 across the face of the panel 100 are not shown in this figure.

Other embodiments of this invention will be obvious in view of the above disclosure.

1-13. (canceled)

14. A structural sheathing panel formed with an array of through pores for the purposes of transmitting water vapor, comprising:
a binder of one or more of magnesium oxide (MgO), calcium oxide, calcium hydroxide, iron oxide (Hematite or Magnetite);
one or more alkali phosphate salts selected from the group consisting of sodium phosphate, potassium phosphate, monopotassium phosphate, tripotassium phosphate, triple super phosphate or dipotassium phosphate; and
water less than or equal to approximately 50% by weight of the sheathing panel.

15. The structural sheathing panel of claim 14 where the binder comprises approximately eighty percent (80%) or less of the overall makeup of the sheathing panel.

16. The structural sheathing panel of claim 14 where the binder comprises approximately fifty percent (50%) or less of the overall makeup of the sheathing panel.

17. The structural sheathing panel of claim 14 where the binder comprises approximately twenty percent (20%) or less of the overall makeup of the sheathing panel.

18. The structural sheathing panel of claim 14 where the binder comprises approximately ten percent (10%) or less of the overall makeup of the sheathing panel.

19. The structural sheathing panel of claim 14 where the binder comprises approximately five percent (5%) or less of the overall makeup of the sheathing panel.

20. The structural sheathing panel of claim 14 further comprising fibers selected from the group consisting of biofibers, nylon, glass and cellulose.

21. The structural sheathing panel of claim 14 further comprising a filler of calcium carbonate and/or perlite.

22. The structural sheathing panel of claim 14 further comprising a filler of ceramic microspheres.

23. The structural sheathing panel of claim 14 further comprising corn starch.

24. The structural sheathing panel of claim 14 further comprising tapioca starch.

25. The structural sheathing panel of claim 14 further comprising a filler of flyash.

26. A structural sheathing panel formed as an uninterrupted panel and then mechanically perforated with an array of through pores for the purposes of transmitting water vapor, comprising:
a binder of one or more of magnesium oxide (MgO), calcium oxide, calcium hydroxide, iron oxide (hematite or magnetite);
one or more alkali phosphate salts selected from the group consisting of sodium phosphate, potassium phosphate, monopotassium phosphate, tripotassium phosphate, triple super phosphate or dipotassium phosphate; and
water less than or equal to approximately fifty percent (50%) by weight of the sheathing panel.

27. The structural sheathing panel of claim 26 where the binder comprises approximately eighty percent (80%) or less of the overall makeup of the sheathing panel.

28-61. (canceled)

62. A method of fabricating a structural sheathing panel, comprising:
forming a slurry comprising:
a binder comprising one or more of magnesium oxide (MgO), calcium oxide, calcium hydroxide and iron oxide (hematite or magnetite); and
at least one alkali phosphate salt; and
allowing the slurry to set in a mold.

63. The method of claim 62 wherein said mold comprises an array of pins of diameter 0.1 mm to 2 mm.

64. The method of claim 62 further comprising drilling the formed panel to form through the panel an array of holes of diameter approximately 0.1 mm to 2 mm.

65. The method of claim 62 including:
adding a material to the slurry to increase the time taken for the slurry to set.

66. The method of claim 64 wherein the material added to the slurry is boric acid.

67. The method of claim 62 wherein the at least one phosphate salt comprises one or more of the following compounds: sodium phosphate, potassium phosphate, monopotassium phosphate, tripotassium phosphate, triple super phosphate or dipotassium phosphate.
